(19) United States
(12) Patent Application Publication
(10) Pub. No.: US 2023/0318999 A1
(43) Pub. Date: Oct. 5, 2023

(54) MESSAGE VALIDATION AND ROUTING IN EXTENDED REALITY ENVIRONMENTS

(71) Applicants: AT & T Intellectual Property I,LP., Atlanta, GA (US); AT & T Mobility II LLC., Atlanta, GA (US)

(72) Inventors: Terrel Lecesne, Round Rock, TX (US); Jason Decuir, Cedar Park, TX (US); Eric Zavesky, Austin, TX (US); James Pratt, Round Rock, TX (US)

(21) Appl. No.: 17/657,951

(22) Filed: Apr. 4, 2022

(51) Int. Cl. H04L 51/212; H04L 51/52; H04L 51/10; H04L 67/131; G06T 19/00

(52) U.S. Cl. CPC H04L 51/212; H04L 51/52; G06T 19/006; H04L 67/131; H04L 51/10

(57) ABSTRACT

In one example, a method includes detecting a new message sent by a first user to a second user, wherein at least the second user is engaged in an extended reality environment, determining whether the new message should be delivered to the second user while the second user is engaged in the extended reality environment, and sending the new message to the second user when it is determined that the new message should be delivered to the second user while the second user is engaged in the extended reality environment, wherein the sending is performed according to a routing strategy that is based on at least one of: a context of the second user or a preference of the second user.

The present disclosure relates generally to extended reality (XR) systems, and relates more particularly to devices, non-transitory computer-readable media, and methods for validating and routing messages in XR environments in a manner that minimizes disruptions to the immersive experience.

### BACKGROUND

Extended reality (XR) is an umbrella term that has been used to refer to various different forms of immersive technologies, including virtual reality (VR), augmented reality (AR), mixed reality (MR), and cinematic reality (CR). Generally speaking, XR technologies allow virtual world (e.g., digital) objects to be brought into “real” (e.g., non-virtual) world environments and real world objects to be brought into virtual environments, e.g., via overlays or other mechanisms. XR technologies may have applications in fields including architecture, sports training, medicine, real estate, gaming, television and film, engineering, travel, and others. As such, immersive experiences that rely on XR technologies are growing in popularity.

### SUMMARY

In one example, the present disclosure describes a device, computer-readable medium, and method for validating and routing messages in XR environments in a manner that minimizes disruptions to the immersive experience. For instance, in one example, a method includes detecting a new message sent by a first user to a second user, wherein at least the second user is engaged in an extended reality environment, determining whether the new message should be delivered to the second user while the second user is engaged in the extended reality environment, and sending the new message to the second user when it is determined that the new message should be delivered to the second user while the second user is engaged in the extended reality environment, wherein the sending is performed according to a routing strategy that is based on at least one of: a context of the second user or a preference of the second user.

In another example, a non-transitory computer-readable medium stores instructions which, when executed by a processor, cause the processor to perform operations. The operations include detecting a new message sent by a first user to a second user, wherein at least the second user is engaged in an extended reality environment, determining whether the new message should be delivered to the second user while the second user is engaged in the extended reality environment, and sending the new message to the second user when it is determined that the new message should be delivered to the second user while the second user is engaged in the extended reality environment, wherein the sending is performed according to a routing strategy that is based on at least one of: a context of the second user or a preference of the second user.

In another example, a device includes a processor and a computer-readable medium storing instructions which, when executed by the processor, cause the processor to perform operations. The operations include detecting a new message sent by a first user to a second user, wherein at least the second user is engaged in an extended reality environment, determining whether the new message should be delivered to the second user while the second user is engaged in the extended reality environment, and sending the new message to the second user when it is determined that the new message should be delivered to the second user while the second user is engaged in the extended reality environment, wherein the sending is performed according to a routing strategy that is based on at least one of: a context of the second user or a preference of the second user.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an image of an example extended reality environment that may be generated by the extended reality server of FIG. 1;

FIG. 3 illustrates a flowchart of an example method for validating and routing messages in extended reality environments in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure preserves immersive experiences in extended reality (XR) environments by validating and routing messages in a manner that minimizes disruptions to the immersive experience. As discussed above, immersive experiences that rely on XR technologies are growing in popularity. Many XR environments support the use of legacy communication methods such as short messaging services (SMS), multimedia messaging services (MMS), and other asynchronous messaging solutions that are not exclusive to XR. For instance, a group of users participating in an immersive experience may exchange a thread of group SMS messages, or a single user participating in an immersive experience may receive an MMS message from a friend or family member who is not participating in the immersive experience. These messages may be displayed in some form within the XR environment.

Integration of these legacy communications into XR environments can be used to enhance the immersive experience (e.g., users in an XR environment may send interactive objects and the like to each other, can coordinate actions, etc.). However, integration of these legacy communications can also prove disruptive to the immersive experience. For instance, the goal of many immersive experiences is to truly make the user feel as if the XR environment is “real.” Aspects of the XR environment, such the visuals, audio, and potentially even smell and ambient conditions (e.g., lighting, temperature, etc.) may be carefully designed and presented to support the perception of realness. Introduction of elements such as SMS messages that have not been similarly designed to support the immersive experience may appear jarring and out of place and may actually make the XR environment feel less immersive to the user. Moreover, many legacy communications systems do not have the capability to differentiate between when the recipient of a communication is or is not participating in an immersive experience. At best, these legacy communications may offer the ability for users to set a “do not disturb” or similar setting that blocks messages or sends predefined responses (e.g., “Unavailable, will respond later”) during certain times of day.

Additionally, many legacy communication methods are targets of unsolicited communications such as advertising, phishing, and the like. Integration of these legacy communication methods into XR environments thus provides the opportunity for such unsolicited communications to enter the immersive experience, which in addition to detracting from the immersive experience may also subject the user to fraud and other unwanted communications.

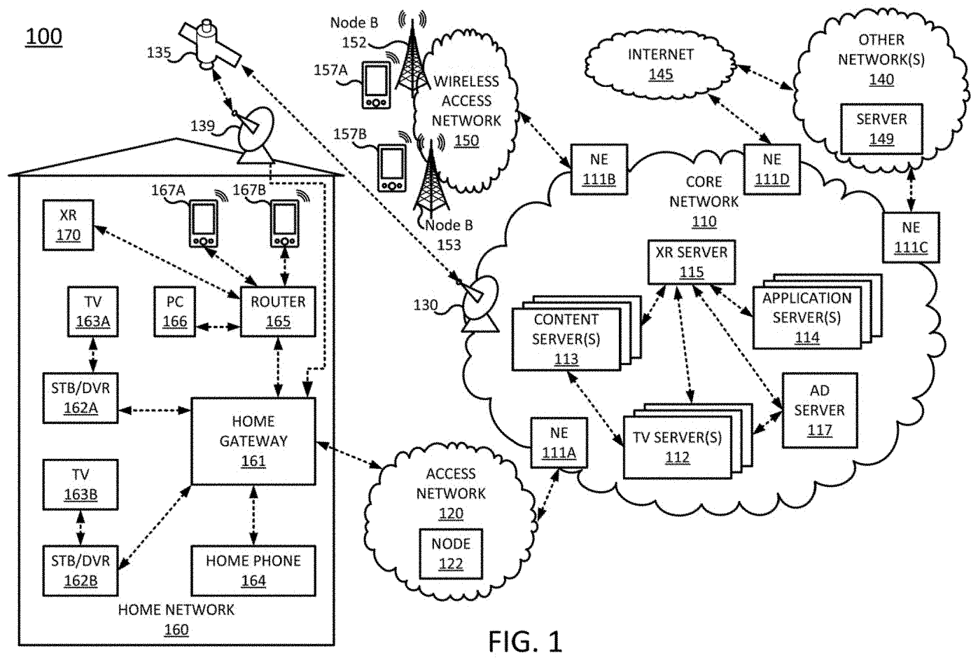

Examples of the present disclosure track users and contexts within an XR environment and use knowledge gained from the tracking to validate and route messages targeted to the users in a manner that minimizes disruptions to the immersive experience in the XR environment. For instance, when an incoming message for a user is detected, examples of the present disclosure may be able to determine whether the user is currently engaged in an XR environment or not. If the user is currently engaged in an XR environment, examples of the present disclosure may be able to determine whether the message is a message that should be presented to the user immediately, delayed until the user is no longer engaged in the XR environment, or blocked all together. In further examples, messages that are presented to the user while the user is engaged in the XR environment may be formatted for presentation in a manner that is compatible with the XR environment, so as not to detract from the immersive experience. These and other aspects of the present disclosure are discussed in greater detail in connection with FIGS. 1-4, below.

To better understand the present disclosure, FIG. 1 illustrates an example network 100, related to the present disclosure. As shown in FIG. 1, the network 100 connects mobile devices 157A, 1578, 167A and 1678, and home network devices such as home gateway 161, set-top boxes (STBs) 162A, and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140 and/or the Internet 145.

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an extended reality (XR) server 115 (e.g., an application server). For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may interact with content servers 113, advertising server 117, and XR server 115 to select which video programs, or other content and advertisements to provide to the home network 160 and to others.

In one example, content servers 113 may store scheduled television broadcast content for a number of television channels, video-on-demand programming, local programming content, gaming content, and so forth. The content servers 113 may also store other types of media that are not audio/video in nature, such as audio-only media (e.g., music, audio books, podcasts, or the like) or video-only media (e.g., image slideshows). For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to viewers, e.g., in the home network 160 and at other downstream viewing locations. For example, advertisers may upload various advertising content to the core network 110 to be distributed to various viewers.

In one example, XR server 115 may generate digital overlays that may be superimposed over images of a “real world” environment (e.g., a real environment surrounding a user) to produce an extended reality environment. For instance, the digital overlays may include renderings of virtual objects that do not exist in the “real world” environment, such as graphics, text, and the like. However, when the digital overlays are superimposed over images of the “real world” environment (e.g., over a live video stream), it may appear to a viewer that the virtual objects are present in the “real world” environment. In some cases, the digital overlays may block the view of the “real world” entirely, so that everything the viewer sees is entirely virtual. Audio, haptic, olfactory, and/or environmental effects may also be generated to further enhance the immersive nature of the extended reality environment. The extended reality environment may comprise, for example, an immersive game, a virtual tour (e.g., of a museum, a tourist attraction, or another point of interest), a virtual class (e.g., a college class, a physical fitness class, etc.), a training simulation (e.g., for a firefighter, a pilot, or the like), a virtual event (e.g., a concert, a play, a speech, or the like).

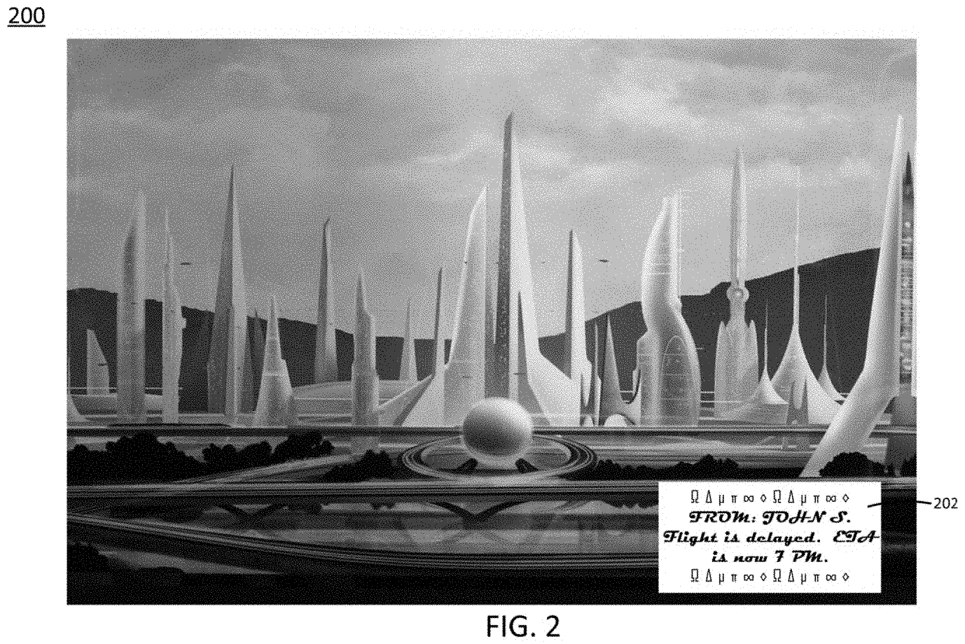

FIG. 2, for instance, illustrates an image of an example extended reality environment 200 that may be generated by the extended reality server 115 of FIG. 1. In this example, the extended reality environment 200 may comprise an immersive game that takes place in a futuristic city. The futuristic city may be displayed, for instance, on the display of a head mounted display that is worn by a user.

While the user is engaged in the immersive game, one of the user's friends may try to contact them using a legacy communication method, such as an SMS message sent via the friend's mobile phone. The friend may not be in the same physical or virtual environment as the user. That is, the friend may be located in a different physical environment than the user and may not be engaged in the immersive game. For instance, the friend may be waiting for a flight at an airport in another city.

Examples of the XR server 115 may detect the incoming message from the user's friend, and may validate the incoming message in order to determine whether the incoming message is a message that should be presented to the user while the user is engaged in the immersive game. In one example, validation of the message may include validating both the sender of the incoming message (e.g., is the sender someone known to the user, or someone known to send malicious or unsolicited messages?) and the content of the incoming message (e.g., does the incoming message relate to time sensitive or urgent subject matter, or can the incoming message wait?).

If the incoming message cannot be validated, in one example the XR server 115 may either refuse receipt of the incoming message or save or re-route the incoming message for later review by the user. However, if the incoming message is a message that should be presented to the user while the user is engaged in the immersive game, then examples of the XR server 115 may determine a routing strategy for the incoming message. The routing strategy may define exactly how the incoming message is to be presented to the user. For instance, the routing strategy may define the device to which the incoming message should be displayed on the head mounted display, sent as an SMS message to the user's smart watch or mobile phone, or the like. The routing strategy may also define formatting for the incoming message, or what the incoming message should look like and how the incoming message should fit into the extended reality environment 200.

For instance, in the example illustrated in FIG. 2, the incoming message is displayed on the display of the head mounted display as a text box 202 that is placed within the extended reality environment 200. In one example, the text box 202 may be placed in an area of the extended reality environment 200 where the text box 202 is unlikely to block the user's view of any interactive objects or real world objects with which the user might collide. Additionally, in the example illustrated in FIG. 2, the text box 202 has been formatted to fit thematically with the extended reality environment 200. For instance, the text of the incoming message may be presented in a futuristic looking font and/or be surrounded by futuristic looking imagery.

Referring back to FIG. 1, in one example the XR server 115 may store user profiles for a plurality of users of the XR system. For instance, each user of the XR system may, upon first login to the XR system, register an account. As part of the account registration process, a user may provide information for or configure the settings of a unique profile for the user. In one example, the user profile for a given user may specify the given user's preferences with respect to the presentation of messages while the given user is engaged in XR environments. For instance, the profile may specify which types of XR environments the given user wishes or does not wish to receive messages while engaged in (e.g., present messages while engaged in virtual tours, but do not present messages while engaged in immersive games), what types of messages the given user wishes or does not wish to receive while engaged in XR environments (e.g., present all urgent or time sensitive messages, but do not present advertising), which other users the given user wishes or does not wish to see messages from while engaged in XR environments (e.g., present all messages from senders on a user-configured whitelist, but never present messages from any senders on a user-configured blacklist), devices on which the given user wishes or does not wish to be presented with messages while engaged in XR environments (e.g., never display messages on a head mounted display, but send to a smart watch when possible), and/or other preferences that may control when and how the XR server presents messages to the given user while the given user is engaged in XR environments.

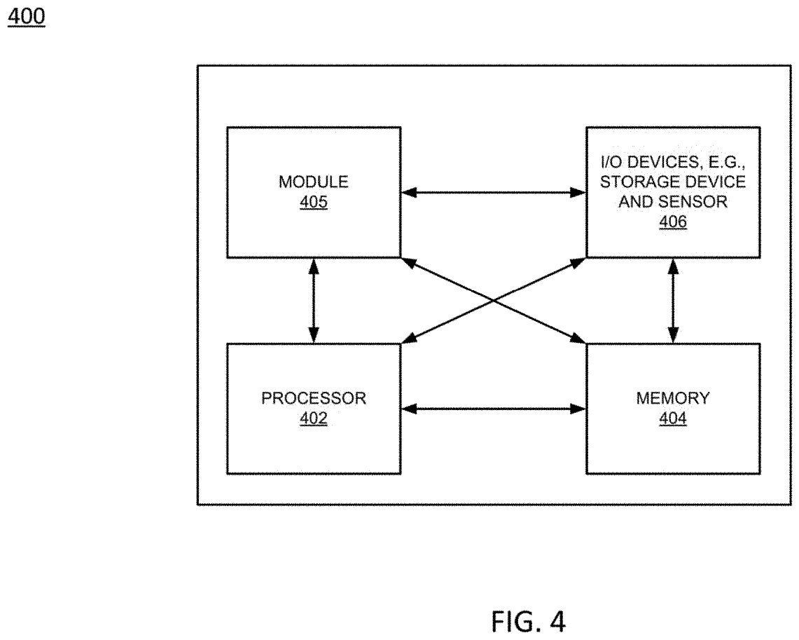

In one example, any or all of the television servers 112, content servers 113, application servers 114, XR server 115, and advertising server 117 may comprise a computing system, such as computing system 400 depicted in FIG. 4.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other types of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, XR device 170, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

In one example, the XR device 170 comprises a device that is capable of rendering a virtual environment that, when experienced simultaneously with a surrounding real environment, creates an XR environment. For instance, the XR device 170 may comprise a head mounted display (HMD). In addition, any of the mobile devices 157A, 157B, 167A, and 167B may comprise or may double as an XR device. For instance, a gaming device or a mobile phone may render XR content.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163A and 163B, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

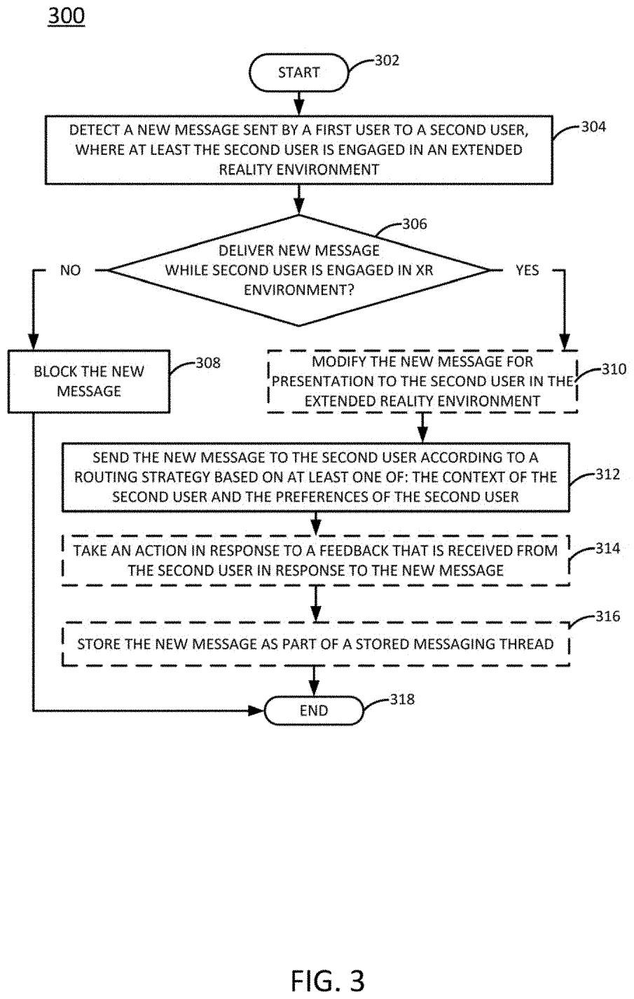

To further aid in understanding the present disclosure, FIG. 3 illustrates a flowchart of an example method 300 for validating and routing messages in extended reality environments in accordance with the present disclosure. In one example, the method 300 may be performed by an XR server that is configured to generate digital overlays that may be superimposed over images of a “real world” environment to produce an extended reality environment, such as the XR server 115 illustrated in FIG. 1. However, in other examples, the method 300 may be performed by another device, such as the processor 402 of the system 400 illustrated in FIG. 4. For the sake of example, the method 300 is described as being performed by a processing system.

The method 300 begins in step 302. In step 304, the processing system may detect a new message sent by a first user to a second user, wherein at least the second user is engaged in an extended reality environment. The new message may be part of a messaging thread between the first user and the second user (and, optionally, one or more additional users). Within the context of the present disclosure, a messaging “thread” is understood to refer to a chronologically ordered series of messages exchanged between at least two users. In one example, the new message may be the first message in the messaging thread. In another example, the messaging thread may be an established messaging thread that already comprises one or more messages that were exchanged prior to the new message.

In one example, the XR environment may comprise an immersive game, a virtual tour (e.g., of a museum, a city, a famous landmark, or the like), a virtual professional conference or meeting, a virtual class (e.g., a college class, a cooking class, a physical fitness class, or the like), a virtual event (e.g., a concert, a speech, a play, or the like), a presentation of an immersive film, a training simulation (e.g., for a pilot, a firefighter, or other professions), or another type of immersive experience that leverages XR technology. In one example, the first user (or the sender of the new message) may or may not be engaged in the XR environment, while the second user (or recipient of the new message) may be engaged in the XR environment.

Either of the first user and the second user may join the XR environment using one or more items of specialized hardware, such as head mounted displays, gaming chairs, projectors, IoT devices, and the like. For instance, the specialized hardware may be capable of displaying three-dimensional, 360 degree, and/or volumetric video or capable of manipulating a user's physical environment in order to alter the ambient conditions within the user's physical environment. Either of the first user and the second user may also or alternatively utilize a device that communicates using a legacy communication method (e.g., a non-XR communication method, such as SMS, MMS, or the like), such as a mobile phone, a voice-activated virtual assistant, a smart wearable device (e.g., a smart watch, a fitness tracker, or the like), or another device.

In one example, either of the first user and the second user may contribute to the messaging thread using specialized XR hardware or non-specialized hardware. For instance, if the first user is not engaged in the XR environment, he or she may utilize his or her mobile phone to contribute to the messaging thread by SMS, which may transmit text- or media-based messages to the second user. The second user, who is engaged in the XR environment, may utilize a microphone in their head mounted display to speak messages which may be transmitted to other users (including the first user) as audio files or text-based transcriptions.

In one example, the new message may comprise a message that was explicitly composed by the first user. For instance, the first user may send the new message to the second user to ask a question, to share information or media, or the like. The new message may or may not be related to the immersive experience of the XR environment. For instance, if the first user and the second user are both engaged in the XR environment, the first message may relate to an activity in the XR environment in which the first user and the second user are both engaged (e.g., exploring a wing of a virtual museum tour, battling the same monster in an XR game, etc.). If the first user is not engaged in the XR environment, the first message may relate to something other than the XR environment (e.g., the first user may send the new message to wish the second user a happy birthday or to ask the second user to stop at the grocery store, etc.).

In other examples, however, the new message may comprise a message that was created automatically, e.g., by the XR system in response to the detection of a predefined event. For instance, a new message may be automatically created in response to the first user and the second user being detected within some defined radius of proximity to each other. As an example, the first user and the second user may both be exploring the same area of an immersive gaming environment or sitting in the same section of a virtual event. In another example, the new message may be created in response to the behavior of one or more of the first user and the second user being detected to meet some predefined criteria. As an example, the first user and the second user may be participating in an immersive gaming environment, and it may be detected that at least one of: first user or the second user needs help based on haptic and/or audio sensors indicating that the at least one of: the first user or the second user has fallen down, has screamed, or the like. In another example, the new message may be created in response to one or more of the endpoint devices used by the first user and the second user being detected to have traveled beyond some expected range (e.g., as might happen if a user has lost his mobile phone, or the mobile phone appears to be moving in a direction away from the user's physical location).

In step 306 the processing system determines whether the new message should be delivered to the second user while the second user is engaged in the extended reality environment. In one example, the determination may be based on the identity of the sender of the new message, the content of the new message, and/or any settings the second user may have configured for message validation while engaged in the XR environment.

For instance, in one example, step 306 may involve authenticating the first user to confirm that messages from the first user are permitted to be delivered to the second user while the second user is engaged in the XR environment. In one example, the second user may define (e.g., in a profile for the second user) a blacklist and/or a whitelist to be used for message validation when the second user is engaged in the XR environment. The blacklist may include a list of senders from whom messages should be rejected or delayed (i.e., not delivered immediately upon receipt) while the second user is engaged in the XR environment, while the whitelist may include a list of senders from whom messages should be accepted (i.e., delivered immediately upon receipt) while the second user is engaged in the XR environment. In one example, the blacklist and/or whitelist may identify senders by email address, email domain, mobile phone number, social media handle, username (e.g., for XR platforms in which users may log in with dedicated credentials), or other identifying information.

In another example, the first user may not be previously known to the second user (e.g., may not be on a blacklist or on a whitelist). In this case, the processing system may indicate to the first user that the new message should remain with the first user (e.g., will not be accepted by a user endpoint device of the second user) until a connection between the first user and the second user can be established. If the connection between the first user and the second user can be established, then the first user may be authenticated and the new message may be delivered to the second user while the second user is engaged in the XR environment.

In another example, authenticating the first user may involve confirming that the first user is within the second user's network (e.g., contacts) or within some degree of relatedness to the second user's network (e.g., within x connections). In another example, the second user may provide a token, a key, or some other credentials to users from whom the second user wishes to accept messages while engaged in the XR environment. In this case, the first user may be authenticated if the new message includes the token, the key, or one or more of the other credentials.

In another example, step 306 may involve scanning the contents of the new message to confirm that the message pertains to subject matter for which the second user wishes to receive messages while engaged in the XR environment. For instance, the second user may indicate (e.g., through settings in a user profile) that he or she may wish to receive messages related to emergencies, breaking news alerts, or otherwise time sensitive matters while engaged in the XR environment. Thus, the processing system may utilize text recognition, natural language processing, or other techniques to scan the contents of the new message for keywords or semantics that indicate that the new message pertains to an emergency (e.g., the appearance of the words “emergency” or “urgent” or “breaking news”). The processing system may also utilize image or symbol recognition techniques to scan images associated with the new message for clues as to the content. For instance, a large red exclamation point may indicate that a high importance is associated with the new message, while the logo of a fast food chain may indicate that the new message is likely a promotion for the fast food chain.

In another example, new messages that relate to the immersive experience in the XR environment may always be delivered to the second user while the second user is engaged in the extended reality environment. For instance, if the XR environment comprises a virtual museum tour, and the new message comprises a reminder to visit a new, short term exhibit that recently opened in the museum, the processing system may determine that the new message should be displayed to the second user while the second user is engaged in the XR environment.

If the processing system concludes in step 306 that the new message should not be delivered to the second user while the second user is engaged in the extended reality environment, then the method 300 may proceed to step 308, and the processing system may block the new message. In one example, blocking the new message may involve rejecting receipt of the new message. Where receipt of the new message is rejected, the processing system may optionally inform the first user that receipt of the new message has been rejected and may indicate a reason for the rejection (e.g., sender unknown or not authorized, content not authorized, etc.). In a further example, the processing system may provide an option for the first user to correct the circumstances that resulted in receipt of the new message being rejected. For instance, if receipt of the new message was rejected because the second user does not accept messages that do not include a token when the second user is engaged in the XR environment, the processing system may suggest that the first user contact the second user to request the token. Similarly, if receipt of the new message was rejected because the second user does not accept messages from senders who are unknown to the processing system when the second user is engaged in the XR environment, the processing system may send a link to the first user by which the first user can register with the processing system to become a known user.

After blocking the new message, the method 300 may end in step 318.

If, however, the processing system concludes in step 306 that the new message should be delivered to the second user while the second user is engaged in the extended reality environment, then the processing system may proceed to optional step 310. In optional step 310 (illustrated in phantom), the processing system may modify the new message for presentation to the second user in the XR environment.

In one example, modification of the new message may involve filtering the new message. For instance, in one example, the second user (or a parent of the second user) may indicate that they do not wish to receive messages containing profanity, images, or other types of content while they are engaged in the XR environment. If the new message includes content that the user has indicated a wish not to receive while engaged in the XR environment, then processing system may remove or otherwise obscure the content that the second user has indicated a wish not to receive from the message. For instance, if the second user does not wish to receive messages that include swearing while engaged in the XR environment, then the processing system may remove, blur, black out, or replace any swear words appearing in the new message.

In another example, modification of the new message may involve adding enhancements to the new message. For instance, certain keywords appearing in the new message may trigger the inclusion of predefined visual effects. As an example, if the new message refers to something that smells bad, the processing system may include visible “stink lines” in and/or around the new message. As another example, if the XR environment in which the second user is engaged is an XR game that takes place in a futuristic setting, then the text of the message could be formatted in a font that matches a font used in the futuristic setting, or presentation of the message could otherwise be enhanced to “blend in” with the XR environment. In another example, if the new message is determined by the processing system to be a high priority message (e.g., an emergency alert), presentation of the message may be enhanced to make the message better stand out or grab the second user's attention.

In step 312, the processing system may send the new message (which may optionally include one or more modifications as discussed in connection with step 310) to the second user according to a routing strategy based on at least one of: the context of the second user or the preferences of the second user. In one example, the routing strategy may comprise a selection of a user endpoint device from among a plurality of user endpoint devices to which to send the new message. For instance, a profile associated with the second user may include information by which to contact the second user at a plurality of user endpoint devices of the second user, including an account with which the second user logs into the XR environment, a mobile phone number, an email address, and the like. The processing system may determine, based on the second user's context and/or preferences (e.g., as indicate din a profile), which user endpoint device of the second user should be used to deliver the new message. For instance, the new message could be displayed on the display of a head mounted display of the second user, directly in the XR environment (e.g., as an overlay or an interactive object). The new message could also be sent as an SMS message to the second user's mobile phone or smart watch or as an email to the second user's email account (which may be accessible via the second user's mobile phone, tablet computer, smart watch, or the like). In this case, the new message might not be visible within the XR environment.

In one example, the context of the second user may comprise an activity in which the second user is currently engaged within the XR environment (e.g., participating in a multiplayer battle in a game, virtually touring a wing of a museum, listening to a song at a virtual concert, etc.). For instance, if the second user is currently engaged in an activity that requires the second user's full attention (e.g., a multiplayer battle), displaying the new message in the XR environment may be distracting. In this case, it may be preferable to send non-urgent new messages to the second user as emails which the second user can review at their leisure. However, if the second user is walking at a relaxed pace through a wing of a virtual museum tour, then displaying a non-urgent new text message in the XR environment may be less distracting.

In another example, the context of the second user may comprise an active or idle messaging thread to which the second user belongs. For instance, the second user may currently be participating in a messaging thread with a plurality other users (e.g., users with whom the second user is currently exploring an area of an XR game). The first user may be one of the plurality of other users and may wish to direct the new message only to the second user (e.g., the first user may wish to propose trading items with the second user) and not to the rest of the messaging thread. In this case, the new message may be routed only to a user endpoint device of the second user, without being routed to the user endpoint devices of the plurality of other users. However, the processing system may (if the second user consents) separately display some indication to the plurality of other users to let the plurality of other users know that the second user is currently participating in another, separate messaging thread. The separately displayed indication may assure the plurality of other users that the second user is still present, but potentially handling another task or messaging thread.

In another example, the context of the second user may comprise the second user's “presence” or availability at a specific user endpoint device. For instance, the processing system may attempt to route an urgent new message to a first user endpoint device of the second user, only to detect that the second user is not available at the first user endpoint device (e.g., the second user may have set an away message, turned the first user endpoint device off, or not provided any input to the first user endpoint device for at least a threshold period of time). In this case, the processing system may then attempt to route the urgent new message to a second user endpoint device of the second user, and may continue to attempt to route the urgent new message to additional user endpoint devices of the second user until the processing system identifies a user endpoint device at which the second user is currently available.

In another example, routing the new message may involve delaying receipt of the message until the user is no longer engaged in the XR environment. For instance, the processing system may route the new message to a message queue, and the second user may, upon logging out of the XR environment, be informed of any pending messages in the message queue. Messages in the message queue may be saved for later viewing by the second user rather than be displayed to the second user automatically upon receipt.

Similarly, a message sent from the first user, whether the first user is or is not immersed in the XR environment, may be delivered to pending message queues both inside and outside of the XR environment. Complementing the use above, a queue internal to the XR environment may benefit the second user by providing a specific context for the last communication (e.g., the queue may include a reminder to return to a certain location in the XR environment, to correlate an action in the XR environment with the initial message from the first user (perhaps as a response of the second user to the initial message), or the like). This dual message queue operation may be managed or updated by the second user (or on behalf of the second user) by a profile setting of the second user. For example, a profile setting may queue the messages in both the real world environment and the XR environment, but persist the XR-based queue indefinitely (e.g., if the second user is excited) while expiring the real-world-based queue after a threshold period of time (e.g., two days).

In another example, the context of the second user may comprise the second user's inferred state of mind. For instance, the processing system may infer the state of mind of the second user based on audible clues, visual clues, biometric clues, and/or other information which may be collected by sensors integrated into the second user's XR devices or located within detection range of the second user. As an example, a microphone integrated into the second user's head mounted display may capture audio uttered by the second user, and the second user's state of mind may be inferred by analysis of the second user's utterances and/or tone (e.g., if the second user is yelling, this may imply that the second user is angry or excited). As another example, a biometric sensor integrated into the second user's smart watch may monitor the second user's heart rate, and the second user's state of mind may be inferred by correlating the second user's current heart rate to a baseline heart rate (e.g., if the current heart rate is within x points of the baseline heart rate, this may imply that the second user is calm or relaxed). As another example, a camera located in the same room as the second user may capture images of the second user, and the second user's state of mind may be inferred by analysis of the second user's facial expressions and/or gestures (e.g., if the second user is smiling or clapping, this may imply that the second user is happy).

A profile of the second user may indicate states of mind in which the second user is most receptive to messages while engaged in XR environments. For instance, the profile may indicate that the second user should not be bothered with obtrusive messages when the second user is agitated or busy, but that the second user is responsive to messages when he or she is happy or relaxed. If there is no profile for the second user, or of the second user's profile does not indicate which states of mind are convenient or inconvenient for sending messages, then the processing system may infer whether it is a good time to send a message to the second user based on how receptive other users displaying similar states of mind to the second user's state of mind were to receiving messages. In one example, if the processing system determines that it is not a good time to send a non-urgent new message to the second user, then the processing system may route the new message to a user endpoint device of the second user that the second user may check at their leisure (e.g., a non-urgent SMS message to the second user's mobile phone).

In another example, the routing strategy may include a determination of where in the XR environment to display the new message. For instance, the processing system may determine that the new message should be displayed to the second user immediately, within the XR environment. But there may be many places within the XR environment where the message could be positioned. In one example, the second user's current context or surroundings may be analyzed to select an appropriate location in the XR environment for the new message to be displayed. For instance, a new message instructing the second user to eat their breakfast may be displayed next to a virtual piece of fruit or bowl of cereal. In another example, the second user's surroundings may be analyzed to locate an area for placement of the new message that will not obstruct the second user's view of real and/or virtual objects in the XR environment. For instance, a message could be displayed over a visible billboard in the background rather than in front of the avatar of another user with whom the second user is talking.

In another example, the new message may be delivered in a manner that is compatible with the XR environment. For instance, if the XR environment is an XR game that takes place in a futuristic setting, the new message could be “delivered” by a non-playable character who is designed to fit into the futuristic setting. In this case, the new message could be converted to audio which is spoken by the non-playable character.

In yet another example, the new message could be formatted by the XR environment to be vocalized, acted out, or visualized by a character, object, or other avatars in the XR environment. For example, if the second user is immersed in a science fiction-based warfare XR game, and the first user is a parent of the second user who has a message for the first user (e.g., that dinner is ready, or a reminder to finish homework or take care of a family pet or other responsibilities), the XR environment may vocalize the message through one of the virtual avatars in the warfare environment, like the admiral (e.g., if the message is high priority), an assistive lieutenant (e.g., if the message is medium priority), or an ambient plant, pet, or wall surface (e.g., if the message is low priority). In each of these scenarios, for further impact or personalization, the vocalization may be stylized for the character, use direct audio from the first user, or be synthesized in the voice of the first user (e.g., where the original message was a text-based message) within the XR environment.

In another example, the message routing may comprise sending a copy of the new message to another device. For instance, if the second user is a child, the child's parent may select a parental control feature in the child's profile that causes the parent to receive copies of any messages sent by or to the child as email messages.

In optional step 314 (illustrated in phantom), the processing system may take an action in response to a feedback that is received from the second user in response to the new message.

In one example, the action may comprise marking the new message as read or unread in a messaging thread that includes the new message. For instance, where the new message is part of a messaging thread between the first user and the second user (and, potentially other users), when the second user reads the new message, a visual indicator may be displayed in the copy of the messaging thread displayed to the first user to let the first user know that the new message was read by the second user. In one example, the visual indicator may comprise changing a color of the new message, displaying an icon beside the new message, or another type of indicator. Similarly, if the second user has deliberately marked the new message as unread, a visual indicator may be displayed in the copy of the messaging thread displayed to the first user to let the first user know that the new message has not yet been read by the second user.

In another example, the action may comprise adding a third user to a messaging thread between the first user and the second user that includes the new message. For instance, upon reading the new message, the second user may determine that the new message is relevant to the third user (who may or may not also be engaged in the XR environment) and may request that the third user be added to the messaging thread by providing an identifier (e.g., the user name in the XR environment, email address, mobile phone number, social media handle, or the like) of the third user.

In another example, the action may comprise re-routing the new message to an automated recipient in response to a request from the second user. For instance, if the second user is too busy to read the new message, the second user may ask that the new message be re-routed to a message queue that the second user may review at a later time.

In another example, the action may comprise providing a summary to the second user of a messaging thread between at least the first user and the second user that includes the new message. For instance, the new message may be sent to the second user within minutes of the second user re-joining the XR environment after some time away from the XR environment. Thus, if the new message relates to a messaging thread that was active during the last time the second user was active in the XR environment (or was active between a plurality of other users while the second user was not active in the XR environment), the second user may request that the processing system provide a summary of the messaging thread for context.

In optional step 316 (illustrated in phantom), the processing system may store the new message as part of a stored messaging thread. For instance, as discussed above, the new message may be part of a messaging thread between the first user and the second user (and, optionally, other users). In one example, the messaging thread may be stored and indexed so that when the first user and/or the second user is engaged in the XR environment, the first user and/or the second user may be able to access the messaging thread, review the messages previously sent in the messaging thread, resume messaging where the messaging thread previously left off, or the like. In one example, messaging threads may be indexed according to the users who participated in the messaging thread, content keywords appearing in the messaging thread, and/or other identifying information.

The method 300 may end in step 318. However, it should be noted that the steps 304-316 of the method 300 may be repeated each time a new message for delivery to the second user is detected.

Although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, the method 300 allows legacy communications methods to be integrated into XR environments in a manner that minimizes any disruption to the immersive experience of the XR environment. Incoming messages for a user who is currently engaged in the XR environment may be screened to determine whether the incoming message should be displayed immediately, saved for later review, or blocked. Messages that are to be displayed immediately may be formatted and routed in a manner that allows the messages to feel like a part of the immersive experience rather than an intrusion. Thus, the user may receive information in a timely manner that is not jarring.

Examples of the present disclosure may be utilized to enhance a variety of XR or immersive experiences. For instance, in one example, examples of the present disclosure may be utilized to enable side conversations between a subset of users who are communicating as part of a thread involving a larger group of users. For instance, a group of friends may be playing an XR game together and may be communicating via a first messaging thread that includes all of the friends. One of the friends may have a question about a surprise birthday party that is being planned for one of the other friends. The friend with the question may not want to ask the question in a manner that ruins the surprise. Examples of the present disclosure may thus create a second messaging thread that includes all of the friends except for the friend whose birthday is coming up. In a further example, rather than routing the messages of the second messaging thread to the XR environment, the messages may be routed to other devices such as the friends' mobile phones, smart watches, email, and the like.

In another example, examples of the present disclosure may be utilized to eliminate spam, phishing, and other unwanted messaging in XR environments. As discussed above, some individuals may attempt to take advantage of the XR environment to distribute unsolicited advertising, viruses, phishing materials, and the like. For instance, an individual may send an interactive object to users of an XR environment, where interaction with the interactive object may result in the download of malware on a user's device. Examples of the present disclosure may filter incoming messages while a user is engaged in an XR environment to ensure that the senders are known to the user, that the content of the incoming messages is safe or is wanted by the user, and the like. Thus, the burden in this case may be placed on the message senders to demonstrate that the messages are legitimate.

In another example, examples of the present disclosure may monitor a user's response rate or attentiveness to messages in determining when and how to deliver messages. For instance, if a user appears to be ignoring or not responding to messages for more than a threshold period of time (e.g., has not reviewed and/or responded to a message in more than x minutes despite messages arriving in that time), then it may be inferred that it is not a good time to display messages to the user. In this case, message delivery may be delayed, or messages may be re-routed from the XR environment to the user's email, smart watch, mobile phone, or the like. In some instances, examples of the present disclosure may first attempt to determine whether network latency may account for the delayed responsiveness (e.g., perhaps the audio and/or video in the messages is not fully loading). Further examples of the present disclosure may display some sort of indicator to other users to let them know that the user is not currently responsive (e.g., a visual indicator such as “AFK” or “away from keyboard,” graying out the non-responsive user's avatar, or the like).

Further examples of the present disclosure may be utilized to improve the accessibility of XR environments. For instance, message routing could take into account the capabilities of a message recipient's endpoint devices as well as any user impairments that might make certain modalities of delivery more desirable than other modalities. For instance, if a user is visually impaired, a text-based message could be reformatted using speech synthesis techniques to be presented as an audio message.

Examples of the present disclosure may be extended further to detect and isolate instances in which an unauthorized individual gains access to a user's account and impersonates the user for the purposes of sending unsolicited XR messages. In this case, the unsolicited messages may be detected, isolated, and removed from messaging threads.

Further extensions may allow a user to route specific types of messages to and/or from specific avatars or digital twins. For instance, an avatar wearing the jersey of the user's favorite football team could be designated to send and receive messages related to sports and/or sports-related immersions, while an avatar of the user that is wearing a superhero costume could be designated to send and receive messages related to a superhero related immersion.

Further extensions still may be integrated into civil audits. For instance, an XR environment according to the present disclosure could be superimposed over a police body camera system for real-time oversight and alert generation.

FIG. 4 depicts a high-level block diagram of a computing device specifically programmed to perform the functions described herein. For example, any one or more components or devices illustrated in FIG. 1 or described in connection with the method 300 may be implemented as the system 400. For instance, a server (such as might be used to perform the method 300) could be implemented as illustrated in FIG. 4.

As depicted in FIG. 4, the system 400 comprises a hardware processor element 402, a memory 404, a module 405 for validating and routing messages in extended reality environments, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for validating and routing messages in extended reality environments may include circuitry and/or logic for performing special purpose functions relating to the operation of a home gateway or XR server. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for validating and routing messages in extended reality environments (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for validating and routing messages in extended reality environments (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

1. A method comprising:
detecting, by a processing system, a new message sent by a first user to a second user, wherein at least the second user is engaged in an extended reality environment;
determining, by the processing system, whether the new message should be delivered to the second user while the second user is engaged in the extended reality environment; and
delivering, by the processing system, the new message to the second user when it is determined that an activity in which the second user is engaged in the extended reality environment at a time that the new message is sent does not require a full attention of the second user.

2. (canceled)

3. The method of claim 1, wherein the new message is delivered via a non-extended reality communication method.

4. The method of claim 3, wherein the non-extended reality communication method comprises a short messaging service or a multimedia messaging service.

5. The method of claim 1, wherein a preference of the second user is stored in a user profile that includes settings configured by the second user for message validation while the second user is engaged in the extended reality environment.

6. The method of claim 5, wherein the determining is performed according to the settings, and the settings include a list of senders from whom the second user wishes to receive messages while engaged in the extended reality environment.

7. The method of claim 5, wherein the determining is performed according to the settings, and the settings include a list of senders from whom the second user does not wish to receive messages while engaged in the extended reality environment.

8. The method of claim 5, wherein the determining is performed according to the settings, and the settings include a list of subject matter for which the second user wishes to receive messages while engaged in the extended reality environment.

9. The method of claim 5, wherein the determining is performed according to the settings, and the settings include a list of subject matter for which the second user does not wish to receive messages while engaged in the extended reality environment.

10. The method of claim 1, wherein the determining always concludes that the new message should be delivered to the second user when the new message relates to an emergency.

11. The method of claim 1, further comprising:
blocking, by the processing system, another new message that is sent to the second user separately from the new message when it is determined that another activity in which the second user is engaged in the extended reality environment when the another new message is sent requires the full attention of the second user.

12. The method of claim 1, wherein the delivering comprises a selection of a user endpoint device from among a plurality of user endpoint devices of the second user to which to deliver the new message.

13. The method of claim 11, wherein the blocking comprises delaying a delivery of the another new message until the another activity no longer requires the full attention of the second user.

14. (canceled)

15. The method of claim 1, further comprising:
blocking, by the processing system, another new message that is sent to the second user separately from the new message when it is determined that an inferred state of mind of the second user is not receptive to receipt of the another new message.

16. The method of claim 1, further comprising:
modifying, by the processing system prior to the delivering, the new message for presentation to the second user in the extended reality environment.

17. The method of claim 16, wherein the modifying comprises formatting a presentation of the new message to fit thematically with the extended reality environment.

18. The method of claim 16, wherein the modifying comprises presenting the new message in a second messaging thread that is separate from a first messaging thread via which the first user, the second user, and at least a third user have been communicating.

19. A non-transitory computer-readable medium storing instructions which, when executed by a processor, cause the processor to perform operations, the operations comprising:
detecting a new message sent by a first user to a second user, wherein at least the second user is engaged in an extended reality environment;
determining whether the new message should be delivered to the second user while the second user is engaged in the extended reality environment; and
delivering the new message to the second user when it is determined that an activity in which the second user is engaged in the extended reality environment at a time that the new message is sent does not require a full attention of the second user.

20. A device comprising:
a processor; and
a computer-readable medium storing instructions which, when executed by the processor, cause the processor to perform operations, the operations comprising:
detecting a new message sent by a first user to a second user, wherein at least the second user is engaged in an extended reality environment;
determining whether the new message should be delivered to the second user while the second user is engaged in the extended reality environment; and
delivering the new message to the second user when it is determined that an activity in which the second user is engaged in the extended reality environment at a time that the new message is sent does not require a full attention of the second user.

21. The method of claim 11, wherein the blocking comprises routing the another new message to a queue to be presented to the second user when the second user exits the extended reality environment.

22. The method of claim 12, wherein the user endpoint device is a user endpoint device other than a user endpoint device on which the extended reality environment is being presented.
